(19) United States
(12) Patent Application Publication
(10) Pub. No.: US 2023/0056632 A1
(43) Pub. Date: Feb. 23, 2023

(54) INFORMATION PROCESSING DEVICE, INFORMATION PROCESSING METHOD, AND STORAGE MEDIUM

(71) Applicant: TOYOTA JIDOSHA KABUSHIKI KAISHA, Toyota-shi Aichi-ken (JP)

(72) Inventor: Shinsuke Sato, Toyota-shi Aichi-ken (JP)

(73) Assignee: TOYOTA JIDOSHA KABUSHIKI KAISHA, Toyata-shi Aichi-ken (JP)

(21) Appl. No.: 17/864,755

(22) Filed: Jul. 14, 2022

(30) Foreign Application Priority Data
Aug. 20, 2021 (JP) 2021-135096

(51) Int. Cl. G06Q 10/08; G06Q 50/02

(52) U.S. Cl. CPC G06Q 10/08345; G06Q 50/02

(57) ABSTRACT

An information acquisition unit of an information processing device acquires crop information of a crop shipped from a farmer. A route acquisition unit acquires information related to a distribution route from the farmer of the crop to a retail store. Next, an estimation unit estimates a transportation distance of the crop, and a determination unit determines whether the transportation distance exceeds a threshold value related to the crop. When the transportation distance exceeds the threshold value, a proposal unit proposes, to the farmer who produces the crop, a cropping plan such that the transportation distance of the crop is equal to or less than the threshold value.

### CROSS-REFERENCE TO RELATED APPLICATION

This application claims priority to Japanese Patent Application No. 2021-135096 filed on Aug. 20, 2021, incorporated herein by reference in its entirety.

### BACKGROUND

### 1. Technical Field

The present disclosure relates to an information processing device, an information processing method, and a storage medium.

### 2. Description of Related Art

In recent years, it has been proposed to control the production and shipment of crops by each farmer based on data and other factors, instead of relying on the experience and intuition of each farmer.

For example, there is proposed in Japanese Unexamined Patent Application Publication No. 2021-82073 (JP 2021-82073 A) a system that generates a learned model using environmental data of the farmland and shipment data of crops produced on the farmland as training data, inputs new environmental data of the farmland as input data to the learned model to estimate the production volume of crops produced on the farmland, and determines cropping plans of the crops based on the estimated production volume of the crops and demand data.

### SUMMARY

The above system does not consider the distribution of crops, especially transportation, and there is room for improvement in that respect.

For example, if the transportation distance of crops from farmlands to retail stores is increased, transportation (distribution) costs will increase and the prices of crops sold to consumers will increase. In addition, distribution costs may increase in order to maintain the freshness of crops.

Further, when the long-distance transportation of crops increases, CO2 (carbon dioxide) emissions from trucks and the like associated with the transportation of crops increase, which is not preferable for the environment.

It is desirable to propose cropping plans that take these issues related to distribution into consideration.

The present disclosure has been made in consideration of the above facts, and an object of the present disclosure is to obtain an information processing device, an information processing method, and a storage medium capable of proposing a cropping plan in consideration of the distribution cost of crops.

An information processing device according to a first aspect includes: an acquisition unit that acquires information related to a crop produced by a farmer; an estimation unit that estimates a distribution cost or an index of the distribution cost related to the crop to be distributed from the farmer to a retail store; a determination unit that determines whether the distribution cost or the index of the distribution cost exceeds a threshold value related to the crop; and a proposal unit that proposes to the farmer a cropping plan in which the distribution cost or the index of the distribution cost of the crop is equal to or less than the threshold value, when the determination unit determines that the distribution cost or the index of the distribution cost exceeds the threshold value.

In the first aspect, when a farmer (including an agricultural corporation or the like) ships a crop, the acquisition unit acquires information related to the crop shipped from the farmer. The information related to the crop is, for example, information on the production area of the crop, information on the production time, and information related to the distribution route of the crop.

Next, the estimation unit estimates the distribution cost or the index of the distribution cost of the crop from the information related to the distribution route of the crop.

Subsequently, the determination unit determines whether the distribution cost or the index of the distribution cost of the crop exceeds the threshold value related to the crop.

When the distribution cost or the index of the distribution cost exceeds the threshold value, the proposal unit proposes, to the farmer who produces the crop, a cropping plan such that the distribution cost or the index of the distribution cost of the crop is equal to or less than the threshold value.

When the farmer implements the cropping plan, the distribution cost of the crop will be reduced. It should be noted that the distribution cost of the crop is also reduced by reducing the index of the distribution cost.

As a result, it is expected that the income of farmers will increase due to the increase in the shipment amount of crops due to the decrease in the selling price of crops at retail stores or the increase in the shipping price of crops. Further, by reducing the distribution cost of crops, for example, the transportation distance of crops, it is possible to reduce the CO2 emission amount associated with the transportation of crops.

In the information processing device according to a second aspect, in the information processing device according to the first aspect, the information related to the crop is information related to production of the crop and information related to distribution of the crop.

According to the second aspect, the information related to the crop acquired by the acquisition unit is the information related to the production of the crop and the information related to the distribution of the crop.

The information related to the crop is, for example, the production area, the production (shipment) time, the production (shipment) amount, etc. of the crop, and is referred to when the proposal unit proposes a cropping plan.

Further, the information related to the distribution of the crop is, for example, the information of the distribution route of the crop from the farmer to the retail store, and is referred to when the estimation unit estimates the distribution cost or the index of the distribution cost of the crop.

In the information processing device according to a third aspect, in the information processing device according to the second aspect, the information related to the production of the crop includes the production area, and the production time or the shipping time of the crop.

According to the third aspect, the information related to the production of the crop acquired by the acquisition unit is the production area information, and the production time or the shipping time of the crop. The production area information of the crop (location information of the production farmland) is referred to when the estimation unit estimates the distribution cost or the index of the distribution cost. Further, the production time or the shipping time of the crop is referred to when the proposal unit proposes a cropping plan.

In the information processing device according to a fourth aspect, in the information processing device according to the second aspect, the information related to the distribution of the crop is at least one of distribution route information, a transportation distance, and a transportation time of the crop to be distributed from the farmer to the retail store.

According to the fourth aspect, the information related to the distribution of the crop is at least one of the distribution route information, the transportation distance, and the transportation time of the crop to be distributed from the farmer to the retail store. For example, the acquisition unit can acquire the distribution route information, and the estimation unit can estimate the distribution cost or the index of the distribution cost (for example, the transportation distance) of the crop based on the distribution route information.

In the information processing device according to a fifth aspect, in the information processing device according to any one of the first aspect to the fourth aspect, the index of the distribution cost is any one of a transportation distance, a transportation time, and a CO2 emission amount associated with transportation of the crop to be distributed from the farmer to the retail store.

According to the fifth aspect, the estimation unit estimates the transportation distance or the transportation time of the crop based on the distribution route information or the like of the crop acquired by the acquisition unit. In addition, the estimation unit can estimate the CO2 emission amount associated with the transportation of the crop based on the transportation distance or the transportation time of the crop. When the index of the distribution cost is the transportation distance or the transportation time and the transportation distance or the transportation time of the crop is acquired by the acquisition unit, the estimation unit uses the transportation distance or the transportation time acquired by the acquisition unit as it is as the index of the distribution cost.

Therefore, when the transportation distance, the transportation time, or the CO2 emission amount associated with the transportation of the crop exceeds the threshold value, the proposal unit proposes a new cropping plan to the farmer. That is, a cropping plan is proposed to the farmer in which the transportation distance and the transportation time of the crop, or the CO2 emission amount associated with the transportation is equal to or less than the threshold value.

By implementing the cropping plan by farmers, the transportation distance, the transportation time, etc. of crops will be reduced, the transportation costs (distribution costs) of crops will be reduced, and the CO2 emission amount associated with the transportation of crops will be reduced, so that the burden on the environment will be reduced. In addition, it is expected that the income of farmers will increase due to the reduction of distribution costs.

In the information processing device according to a sixth aspect, in the information processing device according to the first aspect, the threshold value is changed according to a production time or a shipping time of the crop and a production area.

In the sixth aspect, the threshold value is changed according to the production area, the production time or the shipping time of the crop. For example, during a time when a crop can be harvested all over Japan, the threshold value is set relatively low. On the other hand, during a time when a crop can be produced only in a specific area, the threshold value is set relatively high. By setting the threshold value in this way, for crops that are in demand all year round all over Japan, while allowing the shipment of the crops to distant places during the time when the crops can be cultivated only in specific areas, it is possible to recommend the shipment of the crops to nearby areas during the time when the crops can be cultivated all over Japan.

In the information processing device according to a seventh aspect, in the information processing device according to the first aspect, the cropping plan includes at least one of a change in production amount of the crop, a change in production location, and a change in the crop to be produced, with respect to a conventional cropping plan.

The cropping plan proposed by the proposal unit to the farmer includes at least one of the change in the production amount of the crop, the change in the production location, and the change in the crop. That is, by changing (reducing) the production amount of the crop, changing the production location (changing to the production on a farmland close to the retail store), and changing the crop (changing to a crop with a short transportation distance or the like to the retail store), the distribution cost or the index of the distribution cost can be reduced to be equal to or less than the threshold value.

An information processing method according to an eighth aspect causes a computer to execute processes including: causing an acquisition unit to acquire information related to a crop produced by a farmer; causing an estimation unit to estimate a distribution cost or an index of the distribution cost related to the crop to be distributed from the farmer to a retail store; causing a determination unit to determine whether the distribution cost or the index of the distribution cost exceeds a threshold value related to the crop; and causing a proposal unit to propose to the farmer a cropping plan in which the distribution cost or the index of the distribution cost of the crop is equal to or less than the threshold value, when the determination unit determines that the distribution cost or the index of the distribution cost exceeds the threshold value.

According to the eighth aspect, as in the first aspect, when the distribution cost or the index of the distribution cost of the crop exceeds the threshold value, the proposal unit proposes, to the farmer who produces the crop, a cropping plan such that the distribution cost or the index of the distribution cost of the crop is equal to or less than the threshold value. When the farmer implements the cropping plan, the distribution cost of the crop will be reduced. This is expected to increase the income of farmers and reduce the CO2 emission amount associated with the transportation of crops.

A storage medium according to a ninth aspect stores an information processing program causing a computer to execute processes including: causing an acquisition unit to acquire information related to a crop produced by a farmer; causing an estimation unit to estimate a distribution cost or an index of the distribution cost related to the crop to be distributed from the farmer to a retail store; causing a determination unit to determine whether the distribution cost or the index of the distribution cost exceeds a threshold value related to the crop; and causing a proposal unit to propose to the farmer a cropping plan in which the distribution cost or the index of the distribution cost of the crop is equal to or less than the threshold value when the determination unit determines that the distribution cost or the index of the distribution cost exceeds the threshold value.

According to the ninth aspect, as in the first aspect, when the distribution cost or the index of the distribution cost of the crop exceeds the threshold value, the proposal unit proposes, to the farmer who produces the crop, a cropping plan such that the distribution cost or the index of the distribution cost of the crop is equal to or less than the threshold value. When the farmer implements the cropping plan, the distribution cost of the crop will be reduced. This is expected to increase the income of farmers and reduce the CO2 emission amount associated with the transportation of crops.

The present disclosure is expected to increase the income of farmers and reduce the CO2 emission amount associated with the transportation of crops when farmers implement the proposed cropping plans.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram showing a schematic configuration of an information processing system according to an embodiment;

FIG. 2 is a block diagram showing a hardware configuration of an information processing device;

FIG. 3 is a block diagram showing an example of a functional configuration of the information processing device;

FIG. 4 is a flowchart showing a flow of a process executed by the information processing device;

FIG. 5 is a flowchart showing a flow of a process executed by the information processing device;

FIG. 6 is a diagram schematically showing a state of cropping performed by a farmer before proposing a cropping plan; and

FIG. 7 is a diagram schematically showing a cropping plan for the farmer proposed by the information processing device.

### DETAILED DESCRIPTION OF EMBODIMENTS

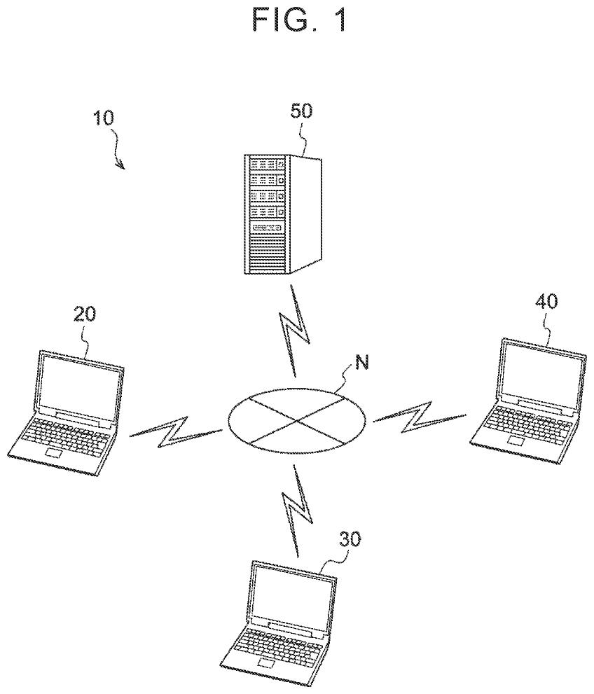

Hereinafter, an information processing system 10 according to an embodiment will be described with reference to FIGS. 1 to 7.

As shown in FIG. 1, the information processing system 10 according to the present embodiment includes a terminal (hereinafter referred to as “farmer terminal”) 20 of a farmer producing crops, a terminal (hereinafter referred to as “distribution terminal”) 30 of one or more companies, groups, etc. involved in the distribution phases of distributing the crops to retail stores, a terminal (hereinafter referred to as “retail store terminal”) 40 of a retail store that sells crops to consumers, and an information processing device (server) 50.

In FIG. 1, one farmer terminal 20, one distribution terminal 30, and one retail store terminal 40 are shown, but multiple terminals may be provided for each terminal.

In addition, “farmer” includes not only individuals who produce crops but also agricultural corporations that produce crops.

The farmer terminal 20 stores a crop identification code (hereinafter referred to as “crop ID”) assigned to each crop shipped by the farmer, a crop production area (location information of the farmland, etc.), a crop production (shipment) time, a crop shipping destination, a shipping amount, a cropping plan of the farmer, and the like. The crop IDs are individually assigned to each shipping unit (for example, each box) of crops.

The distribution terminal 30 stores information (distribution information) related to the distribution route of each crop (crop ID) of the farmer. The number of the distribution terminal 30 may be one, but may be a plural number. For example, if a crop is shipped from a farmer to an agricultural cooperative association (hereinafter sometimes referred to as “agricultural cooperative”), from the agricultural cooperative to a wholesale market, and is moved from the wholesale market to a retail store, information (crop ID, arrival date and time, etc.) indicating that the crop has arrived at the agricultural cooperative and the wholesale market is stored in each of the terminal of the agricultural cooperative and the terminal of the wholesale market. That is, by reading the barcode, IC tag, or the like attached to the cardboard box or the like containing the crop at each transit point, the arrival date and time of the crops at each transit point can be grasped.

The distribution route of the crops is grasped when distribution information is transmitted from each distribution terminal 30 to the information processing device 50 and the information processing device 50 organizes the distribution information related to the same crop ID in chronological order.

The retail store terminal 40 stores information (retail store information) such as the crop ID of the crop and the arrival date and time of the crop by reading the bar code or the like attached to the crop that has arrived at the retail store.

The information processing device 50 is communicably connected to the farmer terminal 20, the distribution terminal 30, and the retail store terminal 40 via a network N. The network N is, for example, a wired and wireless communication network using a public line such as the Internet.

Configuration of Information Processing Device 50

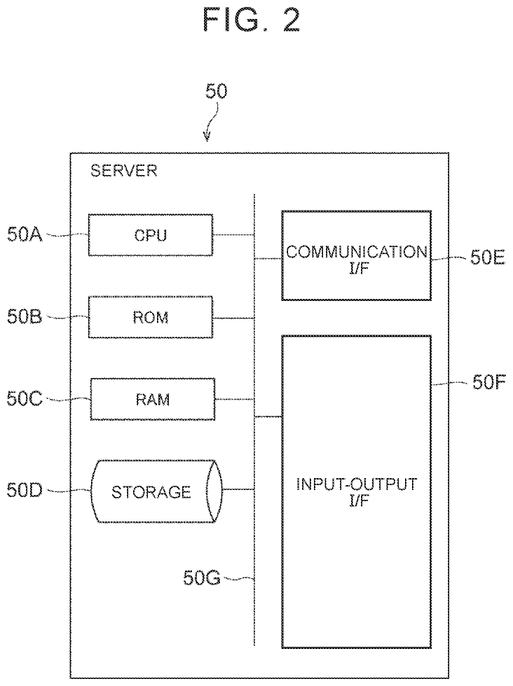

FIG. 2 is a block diagram showing a hardware configuration of the information processing device 50.

As shown in FIG. 2, the information processing device 50 is configured to include a central processing unit (CPU) 50A, a read-only memory (ROM) 50B, a random access memory (RAM) 50C, a storage 50D, a communication interface (I/F) 50E, and an input-output I/F 50F. The CPU 50A, the ROM 50B, the RAM 50C, the storage 50D, the communication I/F 50E, and the input-output I/F 50F are connected so as to be able to communicate with each other via a bus 50G.

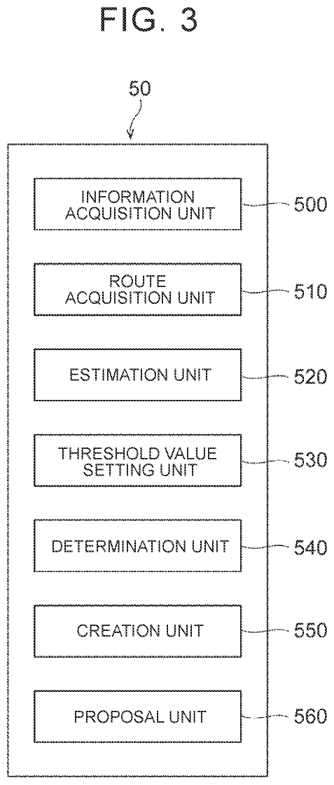

The CPU 50A is a central processing unit that executes various programs and that controls various units. That is, the CPU 50A reads the program from the ROM 50B and the storage 50D and executes the program using the RAM 50C as a work area. When the CPU 50A executes the program, as shown in FIG. 3, the information processing device 50 functions as an information acquisition unit 500, a route acquisition unit 510, an estimation unit 520, a threshold value setting unit 530, a determination unit 540, a creation unit 550, and a proposal unit 560.

As shown in FIG. 2, the ROM 50B stores various programs and various data. The RAM 50C temporarily stores a program or data as a work area. The storage 50D is configured by a hard disk drive (HDD) or a solid state drive (SSD), and stores various programs including an operating system and various data. As will be described later, data of threshold values set for each of the crop variety, the production area, and the production (shipment) time are also stored in the storage 50D. The communication I/F 50E includes an interface for connecting to the network N in order to communicate with the farmer terminal 20, the distribution terminal 30, and the retail store terminal 40. For the interface, for example, communication standards such as long term evolution (LTE) and Wi-Fi (registered trademark) are used.

The input-output I/F 50F is an interface for communicating with a user I/F (not shown). The user I/F is connected to the information processing device 50 of the present embodiment via the input-output I/F 50F. The user I/F may be directly connected to the bus 50G.

Since the farmer terminal 20, the distribution terminal 30, and the retail store terminal 40 have the same configuration as the information processing device 50, detailed description thereof will be omitted.

FIG. 3 is a block diagram showing an example of a functional configuration of the information processing device 50. As shown in FIG. 3, the information processing device 50 includes the information acquisition unit 500, the route acquisition unit 510, the estimation unit 520, the threshold value setting unit 530, the determination unit 540, the creation unit 550, and the proposal unit 560. Each functional configuration is realized when the CPU 50A reads the program stored in the ROM 50B and executes the program.

The information acquisition unit 500 has a function of acquiring crop information transmitted from the farmer terminal 20. The crop information is the crop variety related to the crop ID, the farmland (location) where the crop was produced, the amount of the crop, the shipping date and time, the shipping destination, the cropping plan of the farmer who produced the crop, and the like, which are stored in the farmer terminal 20.

The route acquisition unit 510 has a function of acquiring the distribution (route) information transmitted from the distribution terminal 30 and the retail store terminal 40. The distribution information is information related to the distribution route of the crop from the farmland of the farmer to the retail store in the present embodiment. Specifically, when the bar code (crop ID) attached to the box or the like containing the crop is read at the transit points and the like (the agricultural cooperative and the wholesale market) and the destination (the retail store) of distribution, the crop ID and its arrival time are stored in each distribution terminal 30 at the transit points and the retail store terminal 40. By organizing the information (transit points (location) and retail store (location) information) related to the same crop ID transmitted from the distribution terminal 30 and the retail store terminal 40 in chronological order, the distribution route of the crop can be grasped.

The information acquisition unit 500 and the route acquisition unit 510 correspond to the “acquisition unit”.

The estimation unit 520 has a function of estimating the transportation distance, which is an index of the distribution cost of the crop, based on the distribution route information of the crop grasped by the route acquisition unit 510. For example, the transportation distance between each place is set in advance based on the location information of the farmland, the location information of the collection place of the agricultural cooperative, the location information of the wholesale market, and the location information of the retail store, and the total transportation distance between each place is estimated as the transportation distance of the crop.

The transportation distance may be estimated based on global positioning system (GPS) information (mileage) of a truck or the like that transports the crop between each place.

The threshold value setting unit 530 has a function of setting a threshold value related to the transportation distance for each crop variety based on information such as the production area of the shipped crop and the shipping time. Specifically, the threshold value is set relatively low when the crop can be produced all over Japan. On the other hand, the threshold value is set relatively high when the crop can be produced only in a limited production area. This is because it is considered necessary to ship the crop to distant locations in order to meet the demands of the whole of Japan when the crop can be produced only in a limited area.

The determination unit 540 has a function of determining whether the transportation distance of the crop from the farmer (farmland) to the retail store exceeds a set threshold value.

The creation unit 550 has a function of creating a cropping plan to be proposed to the farmer producing the crop when the transportation distance of the crop exceeds the threshold value in the determination unit 540. For example, the creation unit 550 creates a cropping plan in which, in the farmland where the crop with a transportation distance determined to be equal to or greater than the threshold value was produced, another crop with a transportation distance equal to or less than the threshold value is produced in place of the above crop.

The proposal unit 560 has a function of transmitting the created cropping plan to the farmer terminal 20 of the farmer.

Flow of Control

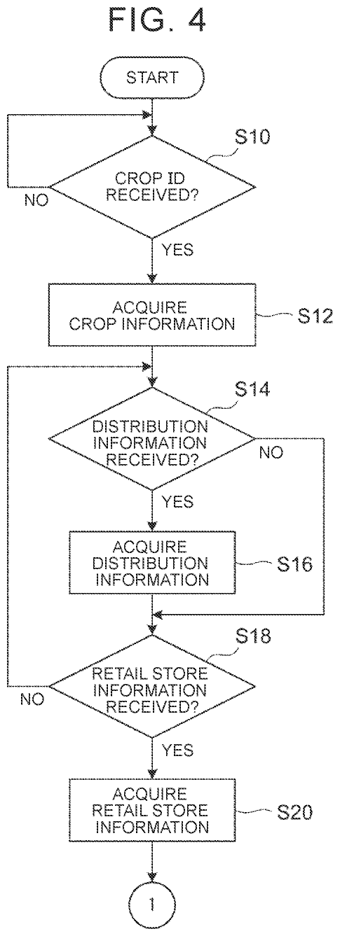

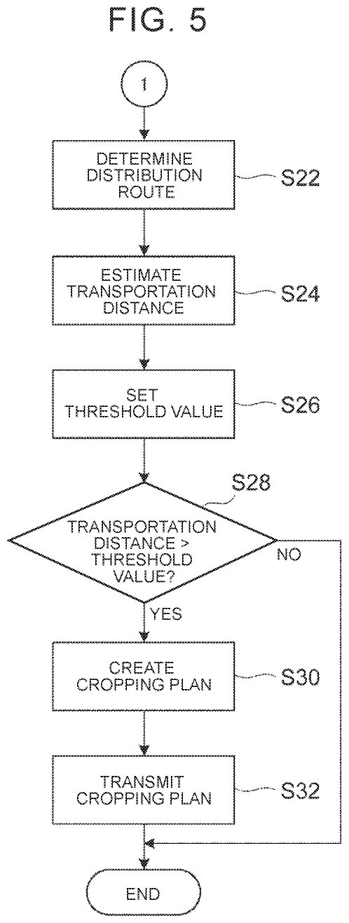

Next, the flow of processes executed by the information processing device 50 constituting the information processing system 10 will be described with reference to the flowcharts of FIGS. 4 and 5.

In step S10 of FIG. 4, the CPU 50A determines whether the crop ID has been received from the farmer terminal 20. When the crop ID is received, the process proceeds to step S12, and when the crop ID is not received, the process returns to step S10.

For example, when a farmer ships a crop, a bar code (crop ID) is attached to a box containing the crop, and the bar code is read at the time of shipment, so that the crop information (shipping date, farmland (location) information, crop variety, etc.) related to the crop and the crop ID are transmitted from the farmer terminal 20 to the information processing device 50 via the network N.

The information processing device 50 grasps the crop (crop ID) for which the distribution route is confirmed by receiving the crop ID in step S10.

In step S12, the CPU 50A acquires the crop information transmitted from the farmer terminal 20 in association with the crop ID.

Next, in step S14, the CPU 50A determines whether the distribution information related to the crop (crop ID) has been received from the distribution terminal 30. Specifically, it is determined whether the distribution information is received based on whether the same crop ID as the crop ID received from the farmer terminal 20 is received from the distribution terminal 30.

The distribution information includes the location information of the transit point on the distribution route of the crop to which the crop ID is attached and at least one of the arrival date and time and the departure date and time of the crop at the transit point.

In step S14, the CPU 50A proceeds to step S16 when the distribution information is received, and proceeds to step S18 when the distribution information is not acquired.

In step S16, the CPU 50A acquires the distribution information related to the crop ID transmitted from the distribution terminal 30.

In step S18, the CPU 50A determines whether the retail store information has been received from the retail store terminal 40. Specifically, it is determined whether the retail store information is received based on whether the same crop ID as the crop ID received from the farmer terminal 20 is received from the retail store terminal 40.

The retail store information is the arrival information (arrival date and time, etc.) of the crop to which the crop ID is attached at the retail store and the location information of the retail store. That is, the acquisition of the retail store information by the CPU 50A means that the crop has arrived at the retail store where the crop is sold to the consumer.

Therefore, when the retail store information is received in step S18, the process proceeds to step S20, and when the retail store information is not received, the process returns to step S14.

The reason step S16 is skipped and the process proceeds to step S18 when the determination result is NO in step S14 is because the distribution information may not be available when the farmer directly ships the crop to the retail store.

In step S20, the CPU 50A acquires the retail store information related to the crop ID transmitted from the retail store terminal 40.

Next, in step S22 of FIG. 5, the CPU 50A specifies a distribution route based on the crop information, the distribution information, and the retail store information related to the same crop ID. For example, the distribution route of the crop is specified, which is, from the farmland where the farmer is located to a collection point of the agricultural cooperative, and from the wholesale market to the retail store.

Subsequently, in step S24, the CPU 50A estimates the distance (transportation distance) for the crop related to the crop ID to be transported from the farmer to the retail store. In the present embodiment, the distances between the transit points on the distribution route of the crop are stored in advance, and the transportation distance of the crop is estimated by integrating the distances. The actual transportation distance may be estimated based on the GPS information (mileage) or the like of a vehicle that transports the crop.

Further, in step S26, the CPU 50A sets a threshold value for the transportation distance based on the crop information related to the crop ID. The threshold value is preset for each of the crop variety, the crop production area, the production time or the shipping time, and is set based on the crop variety information, the location information of the crop production area (farmland), and the shipping time that are included in the crop information.

For example, the threshold value is set relatively high when the crop can be produced only in a specific area, and the threshold value is set relatively low when the crop can be produced all over Japan. In addition, the threshold value is set relatively low during the shipping time when the crop can be produced (shipped) all over Japan, and the threshold value is set relatively high during the shipping time when the crop can be produced (shipped) only in a specific area.

In step S28, the CPU 50A determines whether the transportation distance of the crop related to the crop ID exceeds the threshold value. When the transportation distance of the crop exceeds the threshold value (YES in step S28), the process proceeds to step S30, and when the transportation distance of the crop is equal to or less than the threshold value (NO in step S28), the process ends.

In step S30, the CPU 50A creates a cropping plan to be proposed to the farmer producing the crop to which the crop ID is attached.

For example, a cropping plan is created in which, in the farmland where the crop with a value exceeding the threshold value was produced, a crop with a value equal to or less than the threshold value is produced in place of the above crop.

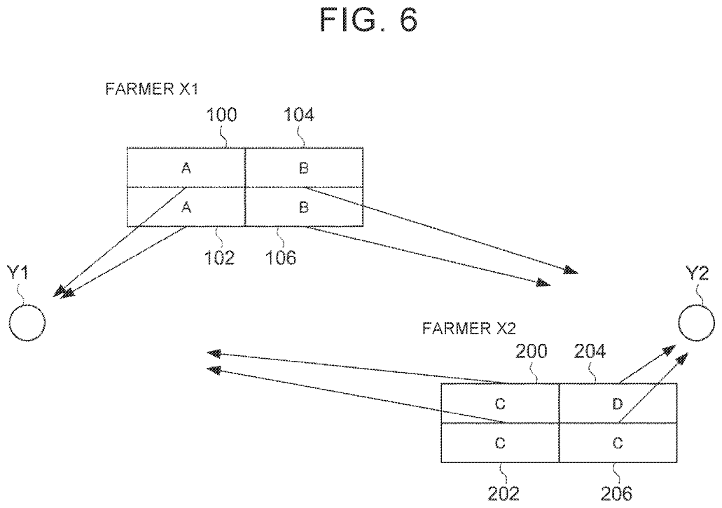

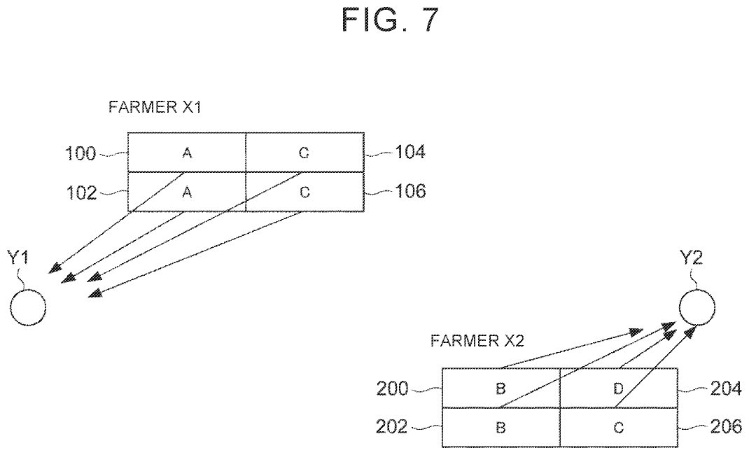

An example of creating a specific cropping plan will be described with reference to FIGS. 6 and 7. The farmers X1, X2 described below are separate farmers, and the retail stores Y1, Y2 are also separate retail stores. Crops A to D are also crops of different varieties.

First, an example of actual cropping performed by the farmers X1, X2 (cropping plan being implemented by the farmers) will be described with reference to FIG. 6. As shown in FIG. 6, the farmer X1 produces the crop A on the farmlands 100, 102, and the crop B on the farmlands 104, 106. Of these, the crop A produced in the farmlands 100, 102 is shipped to the retail store Y1, and the crop B produced in the farmlands 104, 106 is shipped to the retail store Y2.

On the other hand, the farmer X2 produces the crop C on the farmlands 200, 202, 206, and the crop D on the farmland 204. Of these, the crop C produced in the farmlands 200, 202 is shipped to the retail store Y1, and the crop D produced in the farmland 204 and the crop C produced in the farmland 206 are shipped to the retail store Y2.

In such a case, when the CPU 50A of the information processing device 50 determines that the transportation distance of the crop B produced by the farmer X1 on the farmlands 104, 106 exceeds the threshold value Z1, and that the transportation distance of the crop C (shipped to the retail store Y1) produced by the farmer X2 on the farmlands 200, 202 exceeds the threshold value Z2, it is conceivable to create the following cropping plan. The threshold values Z1, Z2 are different values set for crops B, C of different varieties.

As shown in FIG. 7, a cropping plan is created in which the crops B, C with the transportation distance exceeding the threshold value are exchanged between the farmers X1, X2. That is, a cropping plan is created for the farmer X1 including producing the crop C in place of the crop B on the farmlands 104, 106 and shipping the crop C to the retail store Y1, and a cropping plan is created for the farmer X2 including producing the crop B on the farmlands 200, 202 and shipping the crop B to the retail store Y2.

That is, for the farmer X1, a cropping plan is created in which, by shipping the crops A, C to be produced to the retail store Y1, the transportation distances of the crops A, C are equal to or less than the threshold value. Further, for the farmer X2, a cropping plan is created in which, by shipping the crops B, C, D to be produced to the retail store Y2, the transportation distances of the crops B, C, D are equal to or less than the threshold value.

In step S32, the CPU 50A transmits the created cropping plan to the farmer terminal 20 that shipped the crop to which the crop ID is assigned.

### Outline of Present Embodiment

In the information processing system 10 according to the present embodiment, the information processing device 50 detects the distribution route of the crop shipped by the farmer from the farmer (farmland) to the retail store, and estimates the transportation distance of the crop based on the distribution route. When the transport distance of the crop exceeds the threshold value, a new cropping plan is created so that the transportation distance of each crop of the farmer is equal to or less than the threshold value, and is proposed to the farmer.

When the farmer accepts the proposal and changes the cropping of the crop, the transportation distance of the crop, which is an index of the distribution cost, is reduced. As a result, it is expected that the distribution cost of crops of farmers will be reduced and the income of farmers will increase.

In addition, by reducing the transportation distance of crops, the CO2 emission amount associated with the transportation of crops are reduced, and the burden on the environment of crop transportation is reduced.

Furthermore, by reducing the transportation distance of crops, the freshness of crops sold at retail stores is improved. In addition, it is expected that the selling price of crops at retail stores will decrease due to the reduction of the distribution cost of crops.

Furthermore, since the threshold value, which is the criterion for determining the transportation distance of the crops, is set in consideration of the crop variety, the production area, and the production (shipping) time, for example, even when the farmers plant the crops based on the proposed cropping plans, the situation where the crops produced only in a specific area in winter are not shipped to distant locations is prevented or suppressed.

Further, as shown in FIGS. 6 and 7, when the farmers X1, X2 each produce crops B, C with transportation distances exceeding the threshold values Z1, Z2 for the different retail stores Y1, Y2, by proposing a cropping plan to exchange the crops to be produced, the farmers X1, X2 can shorten the transportation distance of the crops to a value equal to or less than the threshold value.

Further, when the crops are exchanged as described above, the shipping destination of the newly produced crops is secured, so that the farmers X1, X2 can easily implement the proposed cropping plan.

### Supplementary Description of Embodiment

In the above embodiment, the transportation distance of the crop is estimated based on the distribution route from the farmland of the crop to the retail store. However, in the case of selling the crop via the Internet, the transportation distance of the crop may be determined based on the distribution route (transportation distance) from the farmland to the consumer.

In the above embodiment, the transportation distance of the crop is used as an index of the distribution cost of the crop. However, the transportation time of the crop may be used as an index of the distribution cost of the crop.

Further, the index of the distribution cost of the crop may be the CO2 emission amount associated with the transportation of the crop, and the determination may be made by comparing the CO2 emission amount and the threshold value. In this case, it is conceivable to estimate the CO2 emission amount associated with the transportation by multiplying the transportation distance or the transportation time of the crop by a predetermined coefficient set for each transportation means (for example, heavy-duty truck, medium-duty truck, light-duty truck, railroad container, ferry, etc.).

It should be noted that the determination may be made not based on the index of the distribution cost, but based on the distribution cost itself. For example, the transportation cost may be estimated based on the transportation distance or the transportation time of the crop, and the transportation cost may be used as the distribution cost and compared with the threshold value.

Further, in the above embodiment, the proposed cropping plan changes (the varieties of) the crops produced on the farmland as compared with the conventional cropping plan, but the present disclosure is not limited to this. The farmland where the crops are produced may be changed, or the production amount of the crops may be changed. Moreover, the combination thereof may be used. The proposed cropping plan only needs to be set so that the distribution cost or the index of the distribution cost of the crops produced and shipped in accordance with the cropping plan is all set to be equal to or less than the threshold value.

Further, various processors other than the CPU may execute the processes that are executed when the CPU 50A reads the software (program) in the above embodiment. Examples of the processors in this case include a programmable logic device (PLD) such as a field-programmable gate array (FPGA) for which a circuit configuration can be changed after production, a dedicated electric circuit that is a processor having a circuit configuration designed exclusively for executing a specific process, such as an application specific integrated circuit (ASIC), and the like. Further, each process may be executed by one of these various processors, or a combination of two or more processors of the same type or different types (for example, a combination of FPGAs, a combination of a CPU and an FPGA, and the like). Further, the hardware structure of these various processors is, more specifically, an electric circuit in which circuit elements such as semiconductor elements are combined.

Further, in the above embodiment, a mode in which the program is stored (installed) in advance in a non-transitory computer-readable recording medium (storage medium) has been described. For example, in the information processing device 50, the program is stored in the storage 50D in advance. However, the present disclosure is not limited to this, and the program may be recorded on a non-transitory recording medium (storage medium) such as a compact disc read-only memory (CD-ROM), a digital versatile disc read-only memory (DVD-ROM), and a universal serial bus (USB) memory to be provided. Further, each program may be downloaded from an external device via a network.

The flow of processes described in the above embodiment is an example, and unnecessary steps may be deleted, new steps may be added, or the process order may be changed within a range that does not deviate from the gist.

In addition, the present disclosure can be implemented with various modifications without departing from the gist thereof. It goes without saying that the scope of the present disclosure is not limited to the above-described embodiment.

What is claimed is:

1. An information processing device comprising:
an acquisition unit that acquires information related to a crop produced by a farmer;
an estimation unit that estimates a distribution cost or an index of the distribution cost related to the crop to be distributed from the farmer to a retail store;
a determination unit that determines whether the distribution cost or the index of the distribution cost exceeds a threshold value related to the crop; and
a proposal unit that proposes to the farmer a cropping plan in which the distribution cost or the index of the distribution cost of the crop is equal to or less than the threshold value, when the determination unit determines that the distribution cost or the index of the distribution cost exceeds the threshold value.

2. The information processing device according to claim 1, wherein the information related to the crop is information related to production of the crop and information related to distribution of the crop.

3. The information processing device according to claim 2, wherein the information related to the production of the crop includes production area information, and a production time or a shipping time of the crop.

4. The information processing device according to claim 2, wherein the information related to the distribution of the crop is at least one of distribution route information, a transportation distance, and a transportation time of the crop to be distributed from the farmer to the retail store.

5. The information processing device according to claim 1, wherein the index of the distribution cost is any one of a transportation distance, a transportation time, and a CO2 emission amount associated with transportation of the crop to be distributed from the farmer to the retail store.

6. The information processing device according to claim 1, wherein the threshold value is changed according to a production time or a shipping time of the crop and a production area.

7. The information processing device according to claim 1, wherein the cropping plan includes at least one of a change in production amount of the crop, a change in production location, and a change in the crop to be produced, with respect to a conventional cropping plan.

8. An information processing method in which a computer executes processes including:
causing an acquisition unit to acquire information related to a crop produced by a farmer;
causing an estimation unit to estimate a distribution cost or an index of the distribution cost related to the crop to be distributed from the farmer to a retail store;
causing a determination unit to determine whether the distribution cost or the index of the distribution cost exceeds a threshold value related to the crop; and
causing a proposal unit to propose to the farmer a cropping plan in which the distribution cost or the index of the distribution cost of the crop is equal to or less than the threshold value, when the determination unit determines that the distribution cost or the index of the distribution cost exceeds the threshold value.

9. A non-transitory storage medium storing an information processing program that causes a computer to execute processes including:
causing an acquisition unit to acquire information related to a crop produced by a farmer;
causing an estimation unit to estimate a distribution cost or an index of the distribution cost related to the crop to be distributed from the farmer to a retail store;
causing a determination unit to determine whether the distribution cost or the index of the distribution cost exceeds a threshold value related to the crop; and
causing a proposal unit to propose to the farmer a cropping plan in which the distribution cost or the index of the distribution cost of the crop is equal to or less than the threshold value when the determination unit determines that the distribution cost or the index of the distribution cost exceeds the threshold value.
